(19) United States
(12) Patent Application Publication
(10) Pub. No.: US 2023/0095398 A1
(43) Pub. Date: Mar. 30, 2023

(54) METHOD FOR PRODUCING BATTERY, AND BATTERY

(71) Applicants: Panasonic Holdings Corporation, Osaka (JP); TOYOTA JIDOSHA KABUSHIKI KAISHA, Aichi-ken (JP)

(72) Inventors: Hiroshi YAMASHITA, Hyogo (JP); Kazutaka NISHIKAWA, Nara (JP); Shigeru KONDOU, Osaka (JP); Noriaki YAMAMOTO, Toyota-shi, Aichi-ken (JP)

(21) Appl. No.: 17/911,383

(22) PCT Filed: Mar. 10, 2021
(86) PCT No.: PCT/JP2021/009539

§ 371 Date: Sep. 13, 2022

(30) Foreign Application Priority Data
Mar. 13, 2020 (JP) 2020-043760

(51) Int. Cl. H01M 10/04; H01M 50/457; H01M 50/46

(52) U.S. Cl. CPC H01M 10/0459; H01M 50/457; H01M 50/461

(57) ABSTRACT

A method for producing a battery, includes: stacking a separator having an adhesive layer and an electrode plate in such a manner that the electrode plate is in contact with the adhesive layer; forming a multilayer electrode body by bonding a part of the electrode plate to the adhesive layer such that the electrode plate has a bonded region bonded with the adhesive layer and a non-bonded region not bonded with the adhesive layer; putting the multilayer electrode body in a case; and injecting an electrolytic solution into the case.

### CROSS-REFERENCE TO RELATED APPLICATIONS

This application is the U.S. National Phase under 35 U.S.C. § 371 of International Patent Application No. PCT/JP2021/009539, filed on Mar. 10, 2021, which in turn claims the benefit of Japanese Patent Application No. 2020-043760, filed on Mar. 13, 2020, the entire content of each of which is incorporated herein by reference.

### BACKGROUND

### Field of the Invention

The present disclosure relates to a method for producing batteries and batteries.

### Description of the Related Art

In recent years, shipments of in-vehicle secondary batteries have been increasing with the spread of electric vehicles (EV), hybrid vehicles (HV), plug-in hybrid vehicles (PHV), and the like. In particular, shipments of lithium-ion secondary batteries are increasing. Further, secondary batteries are becoming widespread not only for in-vehicle use but also as a power source for portable terminals such as laptop computers. Regarding such secondary batteries, for example, Patent Literature 1 discloses producing a multilayer electrode body by stacking and thermo-compressing a separator having an adhesive layer and an electrode, and after the multilayer electrode body is housed in a case, injecting an electrolytic solution into the case so as to produce a secondary battery.
Patent Literature 1: WO 2014/081035

In a secondary battery, an electrode reaction occurs in a state where an electrolytic solution is in contact with an electrode plate. Therefore, when producing a secondary battery, it is necessary to impregnate a multilayer electrode body with an electrolytic solution. On the other hand, in order to increase the energy density of a secondary battery, the volume occupied by a multilayer electrode body inside a case tends to increase. Therefore, the time required for impregnating a multilayer electrode body with an electrolytic solution is increasing. The longer the impregnation time, the longer the production lead time of the secondary battery can be. Further, production facilities may be forced to increase in order to prevent a decrease in the throughput of secondary battery production.

### SUMMARY OF THE INVENTION

In this background, a purpose of the present disclosure is to provide a technique for shortening the impregnation time of a multilayer electrode body with an electrolytic solution.

One embodiment of the present disclosure relates to a method for producing a battery. This method for producing a battery includes: stacking a separator having an adhesive layer and an electrode plate in such a manner that the electrode plate is in contact with the adhesive layer; forming a multilayer electrode body by bonding a part of the electrode plate to the adhesive layer such that the electrode plate has a bonded region bonded with the adhesive layer and a non-bonded region not bonded with the adhesive layer; putting the multilayer electrode body in a case; and injecting an electrolytic solution into the case.

Another embodiment of the present disclosure relates to a battery. This battery includes a multilayer electrode body in which a separator having an adhesive layer and an electrode plate are stacked, an electrolytic solution impregnating the multilayer electrode body, and a case that accommodates the multilayer electrode body and the electrolytic solution. The electrode plate has a bonded region bonded with the adhesive layer and a non-bonded region not bonded with the adhesive layer.

Optional combinations of the aforementioned constituting elements, and implementations of the present disclosure in the form of methods, apparatuses, and systems may also be practiced as additional modes of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view schematically showing a battery according to an embodiment;

FIG. 2 is a plan view schematically showing an electrode plate viewed from the stacking direction of a separator and the electrode plate;

FIGS. 3A-3B are schematic diagrams for explaining the method for producing a battery according to an embodiment;

FIGS. 4A-4B are schematic diagrams for explaining the method for producing a battery according to the embodiment;

FIGS. 5A-5B are schematic diagrams for explaining the method for producing a battery according to the embodiment; and

FIG. 6 is a diagram showing the relationship between time elapsed after the injection of an electrolytic solution and an unimpregnated area in various contact areas.

### DETAILED DESCRIPTION OF THE INVENTION

Hereinafter, the present disclosure will be described based on a preferred embodiment with reference to the figures. The embodiments do not limit the present disclosure and are shown for illustrative purposes, and not all the features described in the embodiments and combinations thereof are necessarily essential to the present disclosure. The same or equivalent constituting elements, members, and processes illustrated in each drawing shall be denoted by the same reference numerals, and duplicative explanations will be omitted appropriately.

The scales and shapes shown in the figures are defined for convenience's sake to make the explanation easy and shall not be interpreted limitatively unless otherwise specified. Terms like “first”, “second”, etc., used in the specification and claims do not indicate an order or importance by any means unless specified otherwise and are used to distinguish a certain feature from the others. Some of the components in each figure may be omitted if they are not important for explanation.

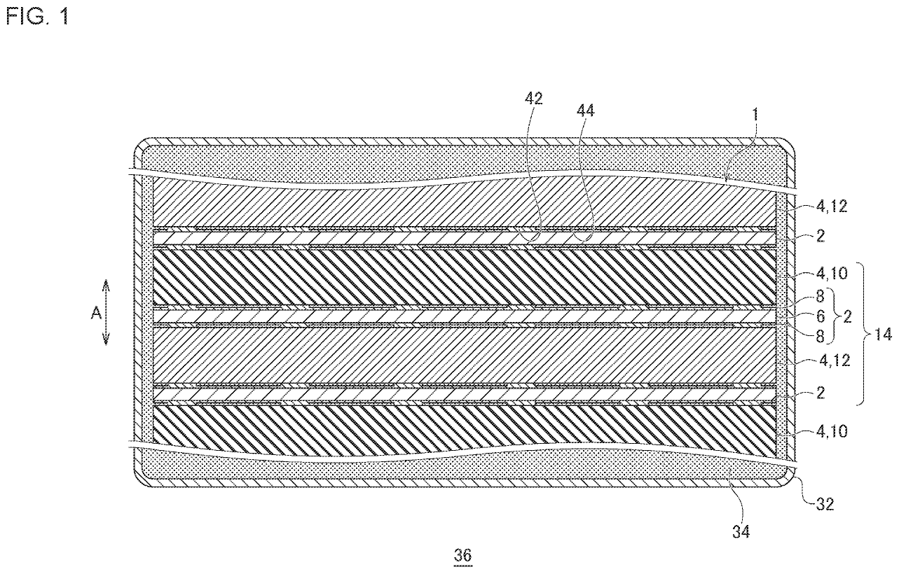

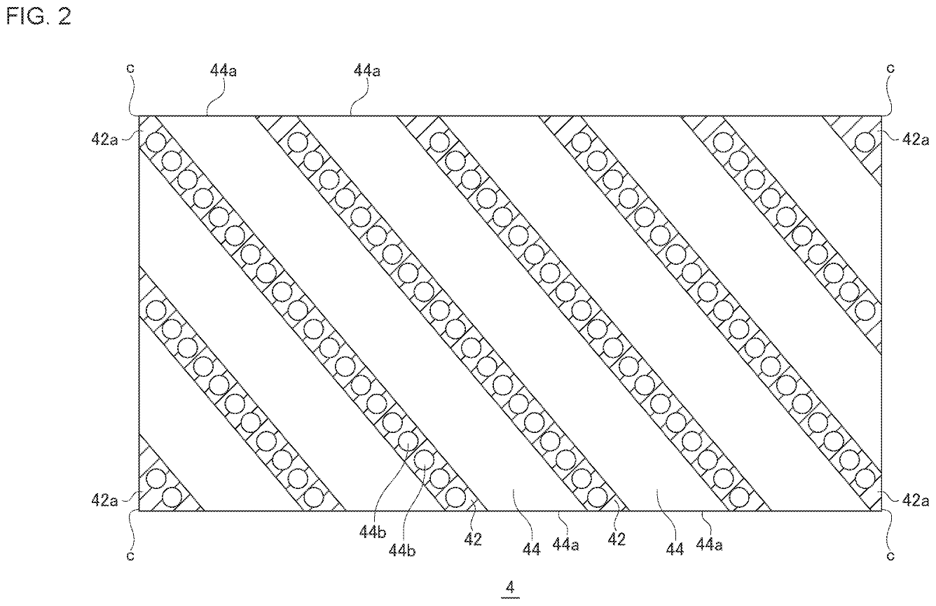

FIG. 1 is a cross-sectional view schematically showing a battery according to an embodiment. FIG. 2 is a plan view schematically showing an electrode plate 4 viewed from the stacking direction of a separator and the electrode plate. A battery 36 includes a multilayer electrode body 1, an electrolytic solution 34, and a case 32. The multilayer electrode body 1 has a structure in which a separator 2 and an electrode plate 4 are stacked.

The separator 2 has a base material 6 and an adhesive layer 8. The base material 6 is, for example, a sheet composed of a microporous membrane made of polyolefin such as polyethylene and polypropylene. The base material 6 may have a monolayer or multilayer structure. The base material 6 preferably has an insulating property. The adhesive layer 8 is provided on at least one main surface of the base material 6. In the present embodiment, the adhesive layer 8 is provided on each side of the base material 6. The adhesive layer 8 is obtained by applying a known adhesive to the surface of the base material 6 using a known coating device. Examples shown as an adhesive that constitutes the adhesive layer 8 are polyvinylidene fluoride (PVDF), etc.

The electrode plate 4 includes a positive electrode plate 10 and a negative electrode plate 12. The positive electrode plate 10 has a structure in which a positive electrode active material layer is stacked on one or both sides of a positive electrode current collector. The positive electrode current collector is composed of, for example, metal foil such as aluminum foil, expanded material, lath material, and the like. The positive electrode active material layer can be formed by applying a positive electrode mixture on the surface of the positive electrode current collector using a known coating device, followed by drying and rolling. The positive electrode mixture is obtained by kneading and mixing materials such as positive electrode active material, binding material, and conductive material into a dispersant and dispersing the materials uniformly.

If the multilayer electrode body 1 is used in a lithium-ion secondary battery, the positive electrode active material is not particularly limited as long as a material that can reversibly absorb and release lithium ions is used. Typically, a lithium-containing transition metal compound can be used as the positive electrode active material. Examples of the lithium-containing transition metal compound include composite oxides containing at least one element selected from the group consisting of cobalt, manganese, nickel, chromium, iron, and vanadium, and lithium.

The binding material is not particularly limited as long as the binding material can be kneaded and dispersed in a dispersant. For example, as the binding material, a fluororesin such as polyvinylidene fluoride or polytetrafluoroethylene, acrylic rubber, acrylic resin, vinyl resin or the like can be used. As the conductive material, a carbon material such as acetylene black, graphite, carbon fiber, etc., can be used. As the dispersant, a solvent capable of dissolving the binding material is used. The positive electrode mixture may contain a dispersant, a surfactant, a stabilizer, a thickener, etc., as needed.

The negative electrode plate 12 has a structure in which a negative electrode active material layer is stacked on one or both sides of a negative electrode current collector. The negative electrode current collector is composed of, for example, metal foil made of copper, copper alloy, or the like, expanded material, lath material, and the like. The negative electrode active material layer can be formed by applying a negative electrode mixture on the surface of the negative electrode current collector using a known coating device, followed by drying and rolling. The negative electrode mixture is obtained by kneading and mixing materials such as negative electrode active material, binding material, and conductive material into a dispersant and dispersing the materials uniformly. The negative electrode plate 12 can also be made by dry methods such as vapor deposition and sputtering instead of the wet method described above.

If the multilayer electrode body 1 is used in a lithium-ion secondary battery, the negative electrode active material is not particularly limited as long as a material that can reversibly absorb and release lithium ions is used. Typically, a carbon material containing graphite with a graphite-type crystal structure can be used as the negative electrode active material. Examples of the carbon material include natural graphite, spherical or fibrous artificial graphite, hard carbon, soft carbon, and the like. As the negative electrode active material, lithium titanate, silicon, tin, and the like can also be used. The same as those used for the positive electrode active material apply to the binding material and the conductive material. The negative electrode mixture may contain a dispersant, a surfactant, a stabilizer, a thickener, etc., as needed.

The electrode plate 4 is stacked on the separator 2 such that the electrode plate 4 is in contact with the adhesive layer 8, and a part of the electrode plate 4 is bonded to the adhesive layer 8. Therefore, the electrode plate 4 has a bonded region 42 bonded with the adhesive layer 8 and a non-bonded region 44 not bonded with the adhesive layer 8. The non-bonded region 44 is a region where the adhesive strength between the separator 2 and the electrode plate 4 in the region is less than 30 percent of the adhesive strength in the bonded region 42, more preferably less than 20 percent, and even more preferably less than 10 percent. The adhesive strength is, for example, 180-degree peel strength (N/25 mm) measured by a method specified in the Japanese Industrial Standard JIS C2107 (1999).

When viewed from the stacking direction A of the separator 2 and the electrode plate 4, the adhesive layer 8 overlaps the entire electrode plate 4. Therefore, viewed from the stacking direction A, the adhesive layer 8 also extends into a region overlapping the non-bonded region 44. The electrode plate 4 has a plurality of non-bonded regions 44 that are independent of one another. That is, the electrode plate 4 has two or more non-bonded regions 44 that are separated by the bonded region 42 and are discontinuous. At least some of the non-bonded regions 44 extend to the outer edge of the electrode plate 4. In other words, at least some of the non-bonded regions 44 have an open end 44a that communicates with an interior space of the case 32. When viewed from the stacking direction A, the electrode plate 4 is rectangular. Further, the electrode plate 4 has a bonded region 42a at a corner C. The electrode plate 4 has a non-bonded region 44b surrounded by the bonded region 42. This non-bonded region 44b does not have an open end 44a since the bonded region 42 extends all around the non-bonded region 44b.

As an example, a bonded region 42 and a non-bonded region 44 are laid out in stripes. More specifically, an individual bonded region 42 and an individual non-bonded region 44 have a linear shape inclined at an angle of 5 to 85 degrees with respect to the long side of the electrode plate 4. The bonded region 42 and the non-bonded region 44 are then arranged alternately. Both ends of each non-bonded region 44 extend to the outer edge of the electrode plate 4, forming open ends 44a. Further, inside each bonded region 42, a plurality of non-bonded regions 44b are arranged at predetermined intervals in a direction in which the bonded region 42 extends.

Bonding of the electrode plate 4 and the adhesive layer 8 allows a multilayer electrode body 1 to be obtained in which the separator 2 and the electrode plate 4 are connected to each other. The multilayer electrode body 1 according to the present embodiment has a structure in which a plurality of unit multilayer bodies 14 are stacked. The number of stackings of a unit multilayer body 14 in the multilayer electrode body 1 is, for example, 30 to 40. The unit multilayer body 14 has a structure in which a positive electrode plate 10, a separator 2, a negative electrode plate 12, and a separator 2 are stacked in this order.

The multilayer electrode body 1 according to the present embodiment is of a stacked type in which a plurality of single plates of a separator 2 and single plates of an electrode plate 4 are stacked. However, the structure is not particularly limited to this structure. The multilayer electrode body 1 needs to have, at least in part, a stacked structure of a separator 2 and an electrode plate 4 bonded to each other and may be of a wound type in which a strip-shaped separator 2 and a strip-shaped electrode plate 4 are wound around each other or a zigzag type in which a single electrode plate 4 is arranged in each groove of a strip-shaped separator 2 folded in a zigzag manner.

The electrolytic solution 34 impregnates the multilayer electrode body 1. The electrolytic solution 34 includes, for example, a non-aqueous solvent and an electrolyte dissolved in the non-aqueous solvent. As the non-aqueous solvent, a known solvent such as ethylene carbonate, propylene carbonate, 1,2-dimethoxyethane, and 1,2-dichloroethane can be used. As the electrolyte, a known electrolyte such as lithium salts with strong electron-withdrawing properties, specifically, LiPF₆, LiBF₄, or the like can be used.

The case 32 houses the multilayer electrode body 1 and the electrolytic solution 34. The case 32 is made of a metal such as aluminum, iron, or stainless steel. The case 32 has a flat rectangular shape. Alternatively, the case 32 may be cylindrical or the like. The case 32 has an opening, through which the multilayer electrode body 1 and the electrolytic solution 34 are placed. This opening is blocked by a sealing plate 18 described later. Therefore, the sealing plate 18 constitutes a part of the case 32.

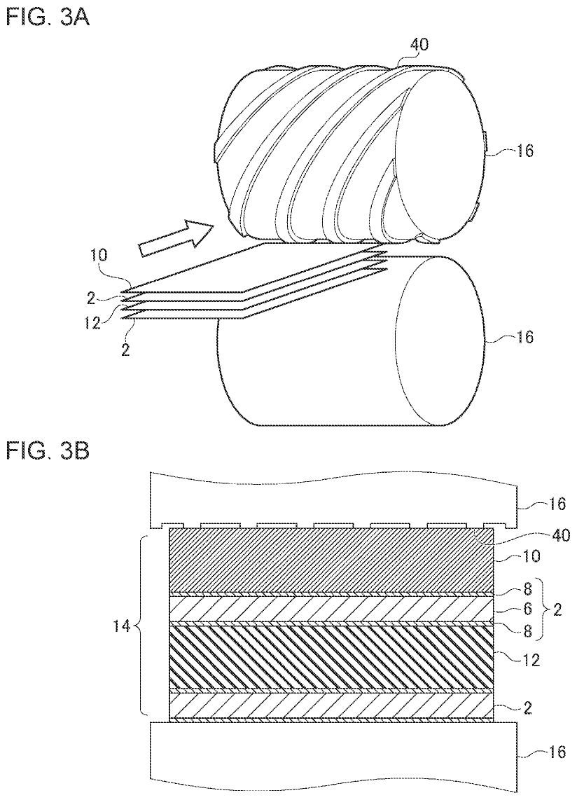

Next, the method for producing a battery 36 according to the present embodiment will be explained. FIGS. 3A to 3B, FIGS. 4A to 4B, and FIGS. 5A to 5B are schematic diagrams for explaining the method for producing a battery 36 according to the embodiment.

<Preparation of Multilayer Electrode Body 1>

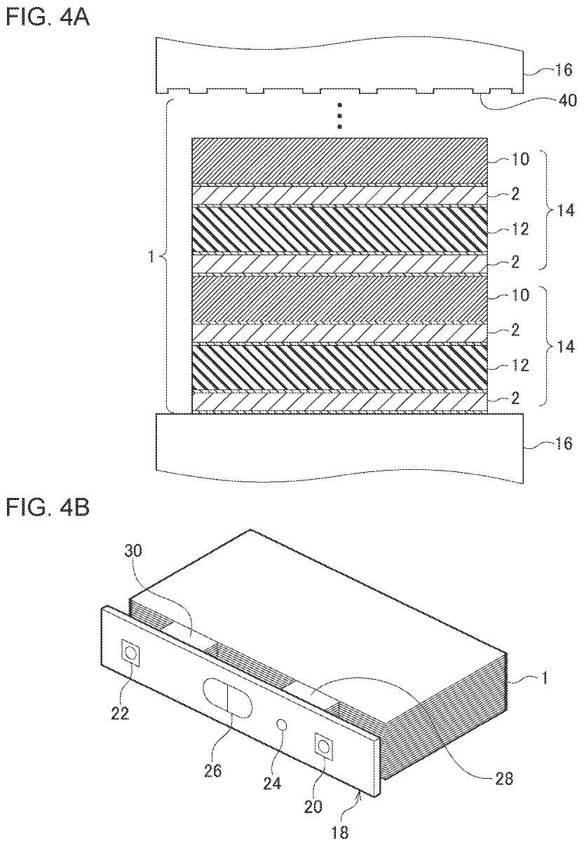

As shown in FIGS. 3A and 3B, a positive electrode plate 10, a separator 2, a negative electrode plate 12, and a separator 2 are passed between a pair of thermo-compression rollers 16. The separator 2 and each electrode plate 4 are stacked in such a manner that the electrode plate 4 is in contact with the adhesive layer 8. This causes the positive electrode plate 10, the separator 2, the negative electrode plate 12, and the separator 2 to be thermo-compressed, and a unit multilayer body 14 is thus obtained. Then, as shown in FIG. 4A, a plurality of unit multilayer bodies 14 are thermo-compressed using a pair of thermo-compression rollers 16. This allows a multilayer electrode body 1 to be obtained.

One of the thermo-compression rollers 16 has a plurality of convex portions 40 on the surface thereof. By applying pressure to the electrode plate 4 and the separator 2 using such a thermo-compression roller 16, only a part of the electrode plate 4 is pressed onto the separator 2, and only the pressed part can be bonded to the adhesive layer 8. By partially bonding the electrode plate 4 to the separator 2, a bonded region 42 and a non-bonded region 44 can be provided on the electrode plate 4.

<Assembly of Battery 36>

As shown in FIG. 4B, a sealing plate 18 is prepared. The sealing plate 18 is made of a metal such as aluminum, iron, or stainless steel. The sealing plate 18 has a positive electrode terminal 20, a negative electrode terminal 22, a liquid injection hole 24, and a safety valve 26. The liquid injection hole 24 is used for injecting an electrolytic solution into the case. The safety valve 26 opens when the internal pressure of the case rises to a predetermined value or above so as to release gas inside the case.

The positive electrode current collector of the multilayer electrode body 1 is electrically connected to the positive electrode terminal 20 via a positive electrode current collector tab 28 for power extraction. Further, the negative electrode current collector of the multilayer electrode body 1 is electrically connected to the negative electrode terminal 22 via a negative electrode current collector tab 30 for power extraction. The positive electrode current collector and the positive electrode current collector tab 28 may form an integrally molded body or may be separate bodies joined by welding or the like. In the same way, the negative electrode current collector and the negative electrode current collector tab 30 may form an integrally molded body or may be separate bodies joined by welding or the like. The positive electrode current collector tab 28 and the positive electrode terminal 20 are joined by welding or the like, and the negative electrode current collector tab 30 and the negative electrode terminal 22 are joined by welding or the like.

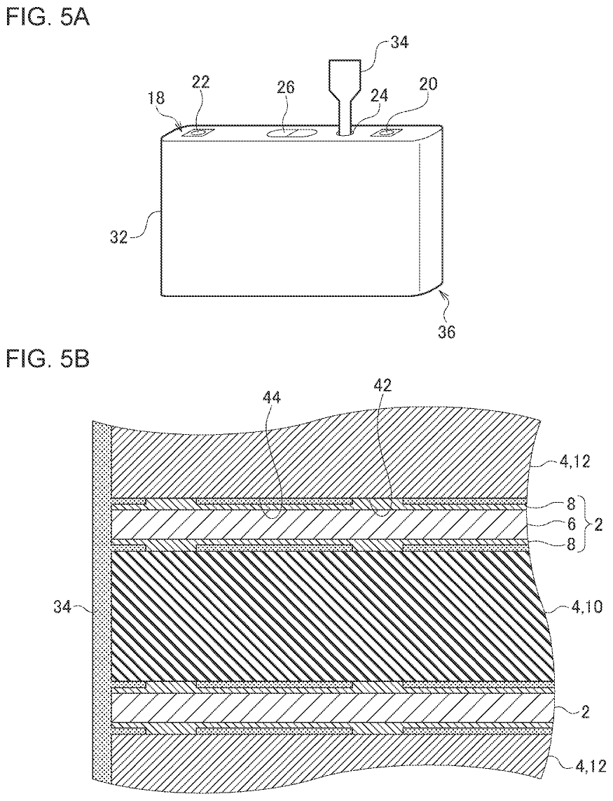

Then, as shown in FIG. 5A, the multilayer electrode body 1 welded to the sealing plate 18 is housed in a case 32. The multilayer electrode body 1 is inserted into the case 32 through the opening of the case 32. Since a plurality of separators 2 and a plurality of electrode plates 4 are connected to each other via an adhesive layer 8, the multilayer electrode body 1 can be easily inserted into the case 32. In particular, since the bonded region 42 is arranged at a corner C of the electrode plate 4, that is, since the four corners of the electrode plate 4 are fixed to the separator 2, the multilayer electrode body 1 can be more easily inserted into the case 32. After inserting the multilayer electrode body 1 into the case 32, the opening of the case 32 is sealed with the sealing plate 18, and the case 32 and the sealing plate 18 are joined by welding or the like.

Then, an electrolytic solution 34 is injected into the case 32 through the liquid injection hole 24. After the electrolytic solution 34 is injected into the case 32, a liquid injection plug (not shown) is joined to the liquid injection hole 24 by welding or the like. This allows the battery 36 to be assembled.

When the electrolytic solution 34 is injected into the case 32, as shown in FIG. 5B, the electrolytic solution 34 enters a gap between a non-bonded region 44 of the electrode plate 4 and the adhesive layer 8 while expanding the gap due to the flow pressure thereof. As the electrolytic solution 34 enters the gap, the air present in the gap is expelled to the outside, and the electrolytic solution 34 and air are smoothly replaced with each other. This allows the electrolytic solution 34 to impregnate the electrode plate 4 quickly.

In other words, the non-bonded region 44 of the electrode plate 4 functions as a flow path for the electrolytic solution 34 and the residual air. In other words, at least some non-bonded regions 44 have an open end 44a that that extends to the outer edge of the electrode plate 4 and communicates with an interior space of the case 32. Therefore, the electrolytic solution 34 can easily enter the gap between the non-bonded region 44 and the adhesive layer 8 through an open end 44a. Further, the residual air can be easily discharged from the open end 44a.

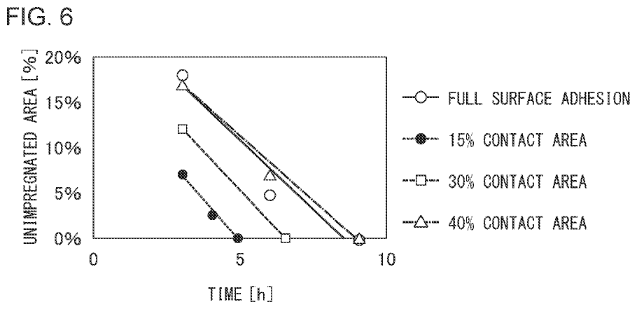

The area of the bonded region 42 is preferably 15 percent or more and less than 40 percent of the total area of the electrode plate 4. FIG. 6 is a diagram showing the relationship between time elapsed after the injection of an electrolytic solution and an unimpregnated area at various contact areas. The “contact area” in FIG. 6 refers to the area of a bonded region 42. Therefore, “full surface adhesion”, “15% contact area”, “30% contact area”, and “40% contact area” mean that the area of the bonded region 42 is 100 percent, 15 percent, 30 percent, and 40 percent, respectively. The “unimpregnated area” means the area of a region of the electrode plate 4 that is not impregnated with the electrolytic solution 34. Whether or not impregnation with the electrolytic solution 34 is occurring can be visually checked. Further, the unimpregnated area can be calculated by image analysis or the like. Also, FIG. 6 shows a plot of the unimpregnated area at a predetermined elapsed time and a straight line obtained by linear approximation of this plot for an experimental section of each contact area.

As shown in FIG. 6, for full surface adhesion, the unimpregnated area was 18 percent after three hours after the completion of the injection of the electrolytic solution 34, 5 percent after six hours, and zero percent after 9 hours. In the case of the 40 percent contact area, the unimpregnated area was 17 percent after three hours, 7 percent after six hours, and zero percent after nine hours. In the case of the 30 percent contact area, the unimpregnated area was 12 percent after three hours, and zero percent after 6.5 hours. In the case of the 15 percent contact area, the unimpregnated area was 7 percent after three hours, 3 percent after four hours, and zero percent after 4.9 hours.

From the above results, it has been confirmed that by setting the area of bonded region 42 to less than 40 percent of the entire area of the electrode plate 4, the impregnation time of the multilayer electrode body 1 with the electrolytic solution 34 can be more certainly shortened. It has been also confirmed that by setting the area of the bonded region 42 to 30 percent or less, the impregnation time can be reduced to about two-thirds of that of the case where no bonded region 42 is provided. Further, it has been confirmed that by setting the area of the bonded region 42 to 15 percent or less, the impregnation time can be reduced to about one half. Also, by setting the area of the bonded region 42 to 15 percent or more, a state in which the electrode plate 4 and the separator 2 are connected can be maintained more securely. Therefore, the handleability of the multilayer electrode body 1 can be maintained.

As explained above, a method for producing a battery 36 according to the present embodiment includes: stacking a separator 2 having an adhesive layer 8 and an electrode plate 4 in such a manner that the electrode plate 4 is in contact with the adhesive layer 8; forming a multilayer electrode body 1 by bonding a part of the electrode plate 4 to the adhesive layer 8 such that the electrode plate 4 has a bonded region 42 bonded with the adhesive layer 8 and a non-bonded region 44 not bonded with the adhesive layer 8; putting the multilayer electrode body 1 in a case 32; and injecting an electrolytic solution 34 into the case 32. By providing a non-bonded region 44 in the electrode plate 4, the electrolytic solution 34 can more easily enter between the electrode plate 4 and the separator 2. This can shorten the impregnation time of the multilayer electrode body 1 with the electrolytic solution 34.

The shortened impregnation time can reduce the production lead time of the battery 36. Further, an increase in production facilities to maintain the throughput of batteries 36 can be avoided, and thus an increase in production space can also be avoided. In addition, it is possible to increase the capacity of a battery 36 while suppressing the extension of the production lead time.

Further, the battery 36 according to the present embodiment includes a multilayer electrode body 1 in which a separator 2 having an adhesive layer 8 and an electrode plate 4 are stacked, an electrolytic solution 34 impregnating the multilayer electrode body 1, and a case 32 that accommodates the multilayer electrode body 1 and the electrolytic solution 34, wherein the electrode plate 4 has a bonded region 42 bonded with the adhesive layer 8 and a non-bonded region 44 not bonded with the adhesive layer 8. In the battery 36, the electrolytic solution 34 can be discharged from the multilayer electrode body 1 by the expansion of the active material during charging. The electrolytic solution 34 returns to the multilayer electrode body 1 by the contraction of the active material during discharging. If the electrolytic solution 34 does not fully return to the multilayer electrode body 1, a region of the electrode plate 4, a part of which is not impregnated with the electrolytic solution 34, i.e., a region that does not contribute to discharging, can be created. In contrast, if the electrode plate 4 has a non-bonded region 44, the electrolytic solution 34 discharged from the multilayer electrode body 1 during charging can smoothly return to the multilayer electrode body 1 during discharging. Therefore, according to the battery 36 of the present embodiment, the charge-discharge characteristics of the battery 36 can be improved, and the cycle life can thus be improved.

When viewed from the stacking direction A of the separator 2 and the electrode plate 4, the adhesive layer 8 overlaps the entire electrode plate 4. Therefore, in the adhesive layer 8, portions to which the electrode plate 4 is bonded, i.e., portions overlapping bonded regions 42, is connected by portions overlapping non-bonded regions 44. Therefore, a portion of the adhesive layer 8 that overlaps a bonded region 42 is prevented from being pressed by the electrode plate 4 and buried in the base material 6 when the electrode plate 4 is pressed onto the adhesive layer 8. This allows flow paths for the electrolytic solution 34 and air to be formed more reliably and the impregnation time with the electrolytic solution 34 to be shortened more securely. Further, the distance between the positive electrode plate 10 and the negative electrode plate 12 can be suppressed from becoming non-uniform, and the electrode reaction can be made uniform throughout the multilayer electrode body 1.

Further, the area of the bonded region 42 is preferably 15 percent or more and less than 40 percent of the total area of the electrode plate 4. This can shorten the impregnation time of the multilayer electrode body 1 with the electrolytic solution 34 more securely and maintain the handleability of the multilayer electrode body 1.

Further, the electrode plate 4 has a plurality of mutually independent non-bonded regions 44, and at least some of the non-bonded regions 44 extend to the outer edge of the electrode plate 4. This makes it easier for the electrolytic solution 34 to enter the gap between the non-bonded regions 44 and the adhesive layer 8 and also makes it easier for the residual air to be discharged. Therefore, the impregnation time of the multilayer electrode body 1 with the electrolytic solution 34 can be further shortened.

The electrode plate 4 has a non-bonded region 44b surrounded by the bonded region 42. That is, the non-bonded region 44b is arranged inside the bonded region 42. This allows the area of the bonded region 42 to be more finely adjusted. Thus, the balance between the shortening of the impregnation time with the electrolytic solution 34 and the maintaining of the handleability of the multilayer electrode body 1 can be easily adjusted.

When viewed from the stacking direction A, the electrode plate 4 is rectangular, and the electrode plate 4 has a bonded region 42 at a corner C. This can further suppress a decrease in the handleability of the multilayer electrode body 1 due to the provision of a non-bonded region 44 in the electrode plate 4.

Described above is a detailed explanation on the embodiments of the present disclosure. The above-described embodiments merely show specific examples for carrying out the present disclosure. The details of the embodiments do not limit the technical scope of the present disclosure, and many design modifications such as change, addition, deletion, etc., of the constituent elements may be made without departing from the spirit of the present disclosure defined in the claims. New embodiments resulting from added design change will provide the advantages of the embodiments and variations that are combined. In the above-described embodiments, the details for which such design change is possible are emphasized with the notations “according to the embodiment”, “in the embodiment”, etc. However, design change is also allowed for those without such notations. Optional combinations of the above constituting elements are also valid as embodiments of the present disclosure. Hatching applied to a cross section of a drawing does not limit the material of an object to which the hatching is applied.

1. A method for producing a battery, comprising:
stacking a separator having an adhesive layer and an electrode plate in such a manner that the electrode plate is in contact with the adhesive layer;
forming a multilayer electrode body by bonding a part of the electrode plate to the adhesive layer such that the electrode plate has a bonded region bonded with the adhesive layer and a non-bonded region not bonded with the adhesive layer;
putting the multilayer electrode body in a case; and
injecting an electrolytic solution into the case.

2. The method for producing a battery according to claim 1, wherein
when viewed from the stacking direction of the separator and the electrode plate, the adhesive layer overlaps the entire electrode plate.

3. The method for producing a battery according to claim 1, wherein
the area of the bonded region is preferably 15 percent or more and less than 40 percent of the total area of the electrode plate.

4. The method for producing a battery according to claim 1, wherein
the electrode plate has a plurality of non-bonded regions that are independent of one another, and
at least some of the non-bonded regions extend to the outer edge of the electrode plate.

5. The method for producing a battery according to claim 1, wherein
the electrode plate has the non-bonded region surrounded by the bonded region.

6. The method for producing a battery according to claim 1, wherein
when viewed from the stacking direction of the separator and the electrode plate, the electrode plate is rectangular, and
the electrode plate has the bonded region at a corner thereof.

7. A battery comprising:
a multilayer electrode body in which a separator that has an adhesive layer and an electrode plate are stacked;
an electrolytic solution that impregnates the multilayer electrode body; and
a case that accommodates the multilayer electrode body and the electrolytic solution, wherein
the electrode plate has a bonded region bonded with the adhesive layer and a non-bonded region not bonded with the adhesive layer.
